(19) United States
(12) Patent Application Publication
(10) Pub. No.: US 2024/0242014 A1
(43) Pub. Date: Jul. 18, 2024

(54) METHODS AND SYSTEMS FOR DESIGNING INTEGRATED CIRCUITS

(71) Applicant: Samsung Electronics Co., Ltd., Suwon-si (KR)

(72) Inventors: Jichull JEONG, Suwon-si (KR); Hyunjoong KIM, Suwon-si (KR); Taehyun KIM, Suwon-si (KR); Euihyun CHEON, Suwon-si (KR)

(73) Assignee: Samsung Electronics Co., Ltd., Suwon-si (KR)

(21) Appl. No.: 18/537,654

(22) Filed: Dec. 12, 2023

(30) Foreign Application Priority Data
Jan. 16, 2023 (KR) 10-2023-0006320

(51) Int. Cl. G06F 30/392

(52) U.S. Cl. CPC G06F 30/392

(57) ABSTRACT

Provided is a method of designing an integrated circuit, the method including generating a layout based on data defining a circuit, receiving at least one state variable of reinforcement learning, and updating the layout based on the at least one state variable, wherein the updating of the layout includes modifying the circuit based on the at least one state variable, synchronizing the circuit with the layout, performing a post-layout simulation based on a result of the synchronization, calculating result value of the simulation, and determining whether to modify the at least one state variable through the reinforcement learning according to the result value.

### CROSS-REFERENCE TO RELATED APPLICATION

This application claims priority under 35 U.S.C. § 119 to Korean Patent Application No. 10-2023-0006320, filed on Jan. 16, 2023, in the Korean Intellectual Property Office, the disclosure of which is incorporated herein by reference in its entirety.

### BACKGROUND

The present inventive concepts relate to methods and systems for designing integrated circuits, and more particularly, to methods of designing integrated circuits through layout synchronization.

As semiconductor technology advances, the design process of integrated circuits is becoming more complex. Accordingly, a simulation process may be advantageous to determine whether an integrated circuit is designed as intended, and whether or not the integrated circuit is optimized may be determined based on the result of the simulation. As a result, the demand for efficiency, accuracy and improved optimization of simulation is increasing.

### SUMMARY

The present inventive concepts provide design methods and systems that may perform more efficient and improved optimization by unifying the simulation based on the layout and the simulation in the dualized schematic stage.

According to some example embodiments, there is provided a method of designing an integrated circuit, the method including generating a layout based on data defining a circuit, receiving at least one state variable of reinforcement learning, and updating the layout based on the at least one state variable, wherein the updating of the layout includes modifying the circuit based on the at least one state variable, synchronizing the circuit with the layout, performing a post-layout simulation based on a result of the synchronization, calculating a result value of the post-layout simulation, and determining whether to modify the at least one state variable through the reinforcement learning according to the result value.

According to some example embodiments, there is provided an integrated circuit design system including a memory configured to store instructions, and at least one processor configured to communicate with the memory and optimize a circuit through simulation by executing the instructions, wherein the at least one processor generates a layout based on data defining the circuit, receives at least one state variable of the circuit, modifies the circuit based on the at least one state variable, synchronizes the circuit with the layout, performs a post-layout simulation based on a result of the synchronization, calculates a result value of the post-layout simulation, and determines whether to modify the at least one state variable according to the result value.

According to some example embodiments, there is provided a method of designing an integrated circuit, the method including generating a layout based on data defining a circuit, receiving at least one state variable of reinforcement learning, modifying the circuit based on the at least one state variable, synchronizing the circuit with the layout, generating input data using the synchronized circuit and the layout, performing a post-layout simulation based on the input data, and determining whether to perform the reinforcement learning on the at least one state variable according to a result of the post-layout simulation.

### BRIEF DESCRIPTION OF THE DRAWINGS

Example embodiments will be more clearly understood from the following detailed description taken in conjunction with the accompanying drawings in which:

FIG. 1 is a block diagram illustrating a circuit design system according to some example embodiments;

FIG. 2 is a flowchart for explaining a design and simulation process for forming an integrated circuit according to some example embodiments;

FIG. 3 is a flowchart illustrating a circuit design method according to some example embodiments;

FIG. 4 is a flowchart for explaining an operation of updating a layout according to some example embodiments;

FIG. 5 is a flowchart for explaining a layout synchronization operation according to some example embodiments;

FIG. 6 is a flowchart illustrating an operation of updating a layout through reinforcement learning according to some example embodiments;

FIG. 7 is a diagram for explaining reinforcement learning according to some example embodiments;

FIG. 8 is a circuit diagram to which a circuit design method according to some example embodiments is applied;

FIG. 9 is a circuit diagram showing a current mode logic (CML) circuit of FIG. 8 according to some example embodiments; and

FIG. 10 is a circuit diagram illustrating a complementary metal-oxide-semiconductor (CMOS) circuit of FIG. 8 according to some example embodiments.

### DETAILED DESCRIPTION

The present inventive concepts will be described more fully hereinafter with reference to the accompanying drawings, in which some example embodiments of the inventive concepts are shown. As those skilled in the art would realize, the described example embodiments may be modified in various different ways, all without departing from the spirit or scope of the present inventive concepts.

Accordingly, the drawings and description are to be regarded as illustrative in nature and not restrictive. Like reference numerals designate like elements throughout the specification. The sequence of operations or steps are not limited to the order presented in the claims or figures unless specifically indicated otherwise. The order of operations or steps may be changed, several operations or steps may be merged, a certain operation or step may be divided, and a specific operation or step may not be performed.

As used herein, the singular forms “a” and “an” are intended to include the plural forms as well, unless the context clearly indicates otherwise. Although the terms first, second, and the like may be used herein to describe various elements, components, steps and/or operations, these terms are only used to distinguish one element, component, step or operation from another element, component, step, or operation.

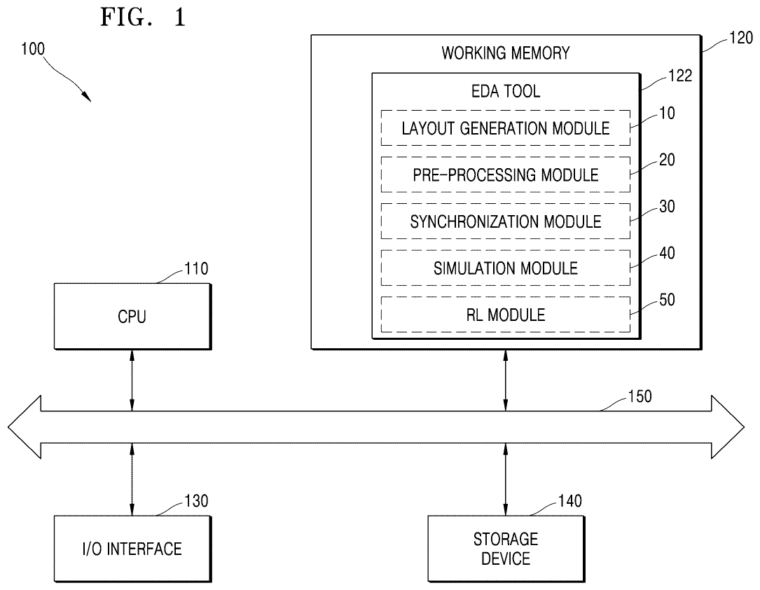

FIG. 1 is a block diagram illustrating a circuit design system according to some example embodiments.

Referring to FIG. 1, a circuit design system 100 includes a central processing unit (CPU) 110 as an example of a processor, a working memory (or memory) 120, an input/output (I/O) interface 130, a storage device 140, and a system bus 150. Here, the circuit design system 100 may be provided as a dedicated device for designing a semiconductor device but may also be a computer for driving various design tools or placement tools.

The CPU 110 may execute software (e.g., application programs, operating systems, device drivers, modules, etc.) to be executed in the circuit design system 100. For example, the CPU 110 may execute an operating system (OS) loaded into the working memory 120. The CPU 110 may execute various application programs or design tools to be driven based on an OS. In some example embodiments, the CPU 110 may be configured to execute instructions that perform at least one of various operations for designing a circuit. For example, the CPU 110 may drive design tools of a semiconductor device loaded into the working memory 120. For example, an electronic design automation (EDA) tool 122 provided as a design tool may be loaded into the working memory 120 and driven by the CPU 110. For example, the CPU 110 drives the EDA tool 122, and by driving a loaded layout generation module 10, a data pre-processing module 20, a synchronization module 30, a simulation module 40, and a reinforcement learning (RL) module 50, integrated circuit design operations may be performed, but example embodiments are not limited thereto. In some example embodiments, although not shown, the CPU 110 may further drive various other modules for designing a circuit.

In some example embodiments, the above modules (e.g., the layout generation module 10, the data pre-processing module 20, the synchronization module 30, the simulation module 40, and the reinforcement learning (RL) module 50) and the term ‘module’ used below may refer to software or hardware components, such as a Field Programmable Gate Array (FPGA) or an Application Specific Integrated Circuit (ASIC), and the ‘module’ may perform certain roles. Additionally, the ‘module’ is not limited to software or hardware. In some example embodiments, the ‘module’ may be configured to be in an addressable storage medium and may be configured to execute one or more processors, but example embodiments are not limited thereto. In some example embodiments, the ‘module’ may include components such as software components, object-oriented software components, class components, and task components, processes, functions, properties, procedures, subroutines, segments of program code, drivers, firmware, microcode, circuitry, data, databases, data structures, tables, arrays, and variables, but example embodiments are not limited thereto. In some example embodiments, functionality provided within components and ‘modules’ may be combined into a smaller number of components and ‘modules’ or further separated into additional components and ‘modules,’ but example embodiments are not limited thereto.

A circuit design method according to some example embodiments may be applied to and executed by the EDA tool 122 and/or the plurality of modules (10 to 50), but example embodiments are not limited thereto. In some example embodiments, at least one of the plurality of modules (10 to 50) according to some example embodiments may be located outside the EDA tool 122 and provided as a separate module or a separate tool.

In some example embodiments, OS or application programs may be loaded into the working memory 120. In some example embodiments, when the circuit design system 100 boots, an OS image stored in the storage device 140 may be loaded into the working memory 120 according to a booting sequence. All I/O operations of the circuit design system 100 may be supported by the OS. Similarly, application programs (e.g., the EDA tool 122) may be loaded into the working memory 120 to be selected by the user or to provide basic services.

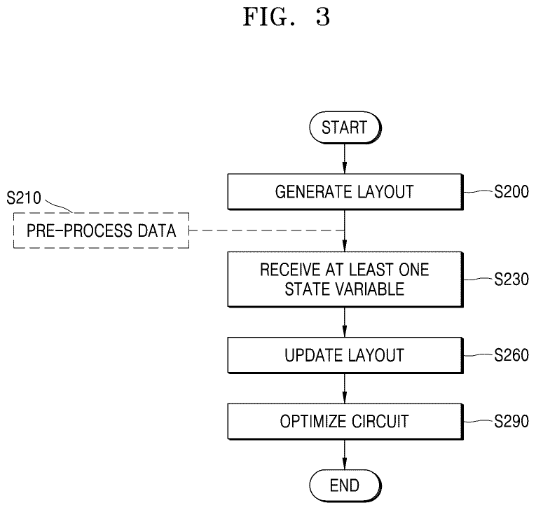

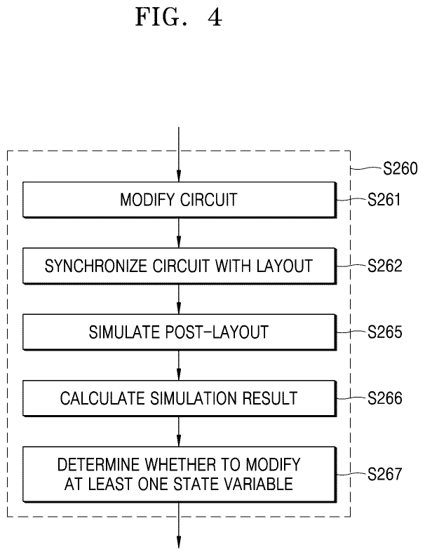

In some example embodiments, as described above, the working memory 120 may store the layout generation module 10, the data pre-processing module 20, the synchronization module 30, the simulation module 40, and the reinforcement learning (RL) module 50, but example embodiments are not limited thereto. The plurality of modules (10 to 50) may be loaded into the working memory 120 from the storage device 140. For example, the layout generation module 10 may be a program including a plurality of instructions for performing a layout generation operation according to some example embodiments, for example, as illustrated in S200 of FIG. 3. The data pre-processing module 20 may be a program including a plurality of instructions for performing a data pre-processing operation according to some example embodiments, for example, as illustrated in S210 of FIG. 3. The synchronization module 30 may be a program including a plurality of instructions for performing a layout synchronization operation according to some example embodiments, for example, as illustrated in S262 of FIG. 4. The simulation module 40 may be a program including a plurality of instructions for performing a post-layout simulation operation according to some example embodiments, for example, as illustrated in S265 of FIG. 4. The reinforcement learning (RL) module 50 may be a program including a plurality of instructions for performing reinforcement learning (e.g., determining whether to modify at least one state variable) according to some example embodiments, for example, as illustrated in S267 of FIG. 4, and for correcting at least one state variable and/or one or more state variables. Detailed operational methods and processes of each module are described with reference to the following drawings, but example embodiments are not limited thereto.

In some example embodiments, the working memory 120 may include a volatile memory, such as Static Random Access Memory (SRAM) or Dynamic Random Access Memory (DRAM), and the like, or a non-volatile memory, such as phase-change random access memory (PRAM), magnetic random access memory (MRAM), resistance random access memory (ReRAM), ferroelectric random access memory (FRAM), flash memory, and the like. However, example embodiments are not limited thereto.

In some example embodiments, the EDA tool 122 may receive data on a schematic circuit and generate a layout based on the schematic circuit. In some example embodiments, to design a circuit that satisfies the criteria a designer aims for, the EDA tool 122 may execute various simulations (e.g., post-layout simulations). During this process, for example, the EDA tool 122 may store a standard cell library or receive a standard cell library from the outside, but example embodiments are not limited thereto. In some example embodiments, standard cells may all have the same unit height. In some example embodiments, standard cells may have different cell widths depending on their types.

In some example embodiments, the EDA tool 122 may perform a simulation, or various simulations, while changing various conditions of the circuit based on the circuit design methods according to some example embodiments to design an optimized circuit. For example, the EDA tool 122 may perform a simulation, or various simulations, while modifying the width or length of a transistor to various values. For example, in some example embodiments, the EDA tool 122 may create a layout by searching for optimal conditions for optimizing the circuit through reinforcement learning.

In addition, in some example embodiments, the EDA tool 122 may modify the circuit based on the modified value (e.g., modified values of a width or length of a transistor) and may modify the layout based on the modified circuit. For example, the EDA tool 122 may perform an operation of synchronizing a circuit with a layout as described in detail below through the circuit design methods according to some example embodiments.

In some example embodiments, the I/O interface 130 may control user inputs and/or outputs from user interface devices. For example, the I/O interface 130 may include an input device such as a keyboard, mouse, or touchpad to receive a netlist file of a semiconductor device and/or configuration information of various standard cells, but example embodiments are not limited thereto. Also, in some example embodiments, the I/O interface 130 may display progress and/or process results in the design operation and/or operations of the circuit design system 100 by having an output device such as a monitor, but example embodiments are not limited thereto.

In some example embodiments, the storage device 140 may be provided as a storage medium of the circuit design system 100. The storage device 140 may store application programs, OS images, and a variety of data, but example embodiments are not limited thereto. For example, the storage device 140 may store various types of data related to the plurality of modules (10 to 50). Also, for example, the storage device 140 may store data about a skew generated in a circuit or a duty cycle of an output signal as a simulation result of the EDA tool 122, but example embodiments are not limited thereto. The storage device 140 may be provided as a memory card (e.g., a multi-media card (MMC), an embedded multi-media card (eMMC), a secure digital (SD), a MicroSD, etc.), a hard disk drive (HDD), or a solid-state drive, but example embodiments are not limited thereto. In some example embodiments, the storage device 140 may include a NAND-type flash memory having a large storage capacity. Alternatively, the storage device 140 may include a next-generation nonvolatile memory, such as PRAM, MRAM, ReRAM, FRAM, or flash memory, but example embodiments are not limited thereto.

In some example embodiments, the system bus 150 may serve as an interconnector for providing a network inside the circuit design system 100. For example, through the system bus 150, the CPU 110, the working memory 120, the I/O interface 130, and the storage device 140 are electrically connected and may exchange data with each other. However, the configuration of the system bus 150 is not limited to the above example embodiments and in some example embodiments may further include mediation means for efficient management.

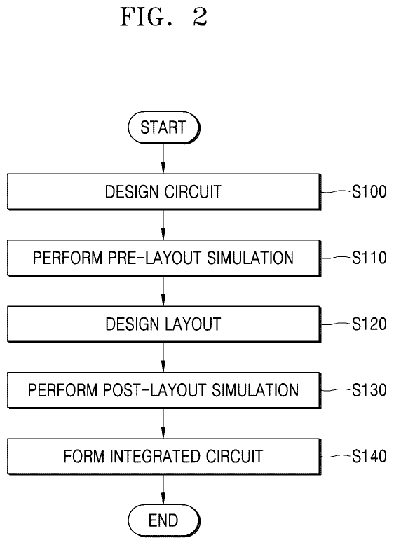

FIG. 2 is a flowchart for explaining a design and simulation process for forming an integrated circuit according to some example embodiments.

Referring to FIG. 2, in some example embodiments, first, a semiconductor device and/or circuit may be designed in S100. For example, various elements (e.g., transistors, etc.) may be designed to satisfy the performance of a circuit element to be formed. For example, an element may be designed based on high level description, register transfer language (RTL) coding, synthesis, and the like, but example embodiments are not limited thereto. For example, high-level technology and/or high-level description may mean executing a computer program in a high-level language such as C language. RTL coding may mean designing using a hardware description language (HDL). Synthesis may refer to a process of converting RTL code into a gate-level netlist using a synthesis tool. However, example embodiments are not limited thereto.

In some example embodiments, based on the circuit designed in S100, a pre-layout simulation may be performed to test the performance of the circuit in S110. For example, a gate level simulation may be performed, and is a verification simulation of whether synthesis has been performed properly, and the gate level simulation may be performed through Static Timing Analysis (STA), and a test vector may be considered together, but example embodiments are not limited thereto. Furthermore, in some example embodiments, the structure of the circuit may be modified according to a result of the pre-layout simulation performed in S110.

In some example embodiments, after performing the pre-layout simulation in S110, layout design may be performed based on the pre-layout simulation result in S120. According to some example embodiments, the layout design performed in S120 may refer to a process of arranging cells and connecting wires based on a design rule and may include a Place and Routing (P&R) process, but example embodiments are not limited thereto. In some example embodiments, the design rule may define a plurality of rules based on a process of manufacturing an element of a circuit. In some example embodiments, the layout design operation in S120 may include performing Design Rule Check (DRC) and Layout Versus Schematic (LVS), but example embodiments are not limited thereto. In some example embodiments, the DRC is the process of checking if the layout is properly done with physical dimension spacing according to the design rule after the layout is completed, and the LVS is the process of checking if the circuit and layout are properly matched. In addition, in some example embodiments, the layout design operation in S120 may also include performing an Electric Rule Check (ERC) to check whether elements or wires are properly electrically connected, but example embodiments are not limited thereto.

According to some example embodiments, when the layout of the circuit is completed through the above processes (e.g., design circuit S100, perform pre-layout simulation S110, and design layout S120), post-layout simulation may be performed based on the completed layout in S130. The post-layout simulation performed in S130 may refer to a process of checking the functional completeness of the layout by extracting and simulating parasitic components, for example parasitic capacitance, from the layout, but example embodiments are not limited thereto. In some example embodiments, when the result of performing the post-layout simulation in S130 satisfies the design requirements, output data defining the circuit may be provided to the semiconductor process module (for example, the circuit design system 100). In some example embodiments, the output data may have a format including all layout information of standard cells, that is, pattern information in all layers, for example, a Graphic Design System (GDS) II format, or have a format including external information of the standard cell, such as a pin of the standard cell, for example, an LEF format or a Milkyway format, but example embodiments are not limited thereto.

In some example embodiments, an integrated circuit may be formed based on the output data, for example, layout data, in S140. For example, the integrated circuit forming operation in S140 may include performing an optical proximity correction (OPC) operation, a mask manufacturing operation, a front-end-of-line (FEOL) process, a back-end-of-line (BEOL) process, and the like, but example embodiments are not limited thereto. According to some example embodiments, an integrated circuit may be designed through the above processes, but example embodiments are not limited thereto.

As described above, in some example embodiments, the structure of the integrated circuit may be changed according to the result of performing the pre-layout simulation in operation S110. In some example embodiments, even if a target condition is satisfied as a result of performing a pre-layout simulation in operation S110 and a layout is designed based on this in operation S120, as a result of performing post-layout simulation in operation S130 based on the designed layout, the actual layout may not satisfy the target condition. In this case, the pre-layout simulation operation in S110 and the post-layout simulation operation in S130 may have to be repeated again.

However, the circuit design methods according to some example embodiments may reduce or prevent unnecessary repetition of simulation due to mismatch between the results of the pre-layout simulation operation in S110 and the post-layout simulation operation in S130 by reflecting changes in the schematic stage (e.g., modifications in the circuit) in the layout, for example, by synchronizing the circuit with the layout. In addition, the circuit design methods according to some example embodiments reflect the result of the post-layout simulation performed in operation S130 and synchronizes the circuit with the layout, such that the circuit design methods according to some example embodiments may reduce resources and time required for circuit optimization, and may further achieve more effective and/or advantageous circuit optimization. A detailed process and effect thereof will be described in more detail with reference to the following drawings.

FIG. 3 is a flowchart illustrating a circuit design method according to some example embodiments.

Referring to FIGS. 1 and 3, a circuit design method according to some example embodiments may optimize a circuit by synchronizing a layout through various modules.

For example, in some example embodiments, the EDA tool 122 (or the layout generation module 10) to which the circuit design method according to some example embodiments is applied may generate a layout based on the circuit in an initial state in S200. In addition, in some example embodiments, the EDA tool 122 may receive state variables representing various conditions of the circuit with various values, for example, the EDA tool 122 may receive at least one state variable in S230, but example embodiments are not limited thereto. In some example embodiments, the EDA tool 122 may receive one or more state variables. In some example embodiments, the at least one state variable may be a variable representing a width and/or a length of a transistor included in a circuit. For example, the EDA tool 122 may receive a state variable or at least one state variable indicating the size of a certain transistor. As described below, the EDA tool 122 may modify the circuit based on the value of the at least one state variable.

In some example embodiments, the data pre-processing module 20 may perform an operation of processing data for synchronizing and simulating a layout according to some example embodiments, as described below. For example, the data pre-processing module 20 may modify data of the layout created in S200. For example, the EDA tool 122 may create a layout in operation S200 based on the provided standard cell, and in some example embodiments as stated above, when changing the size of some transistor(s) among the transistors by a state variable and/or by the at least one state variable, the sizes of all transistors as well as the sizes of some of the transistor(s) may be modified if there is no separate data processing process. In this case, it may be difficult to automate layout synchronization, as described below. For example, the data pre-processing module 20 may modify data so that a certain modification of a circuit by at least one state variable is automatically reflected in a layout. For example, the data pre-processing module 20 may perform a pre-processing operation in S210 based on a GDS format file representing layout data (for example, defining a layout), but example embodiments are not limited thereto. In some example embodiments, the data pre-processing module 20 may modify a cell name defining a cell of each transistor on the GDS file. For example, a cell may be newly defined by reflecting layer information. However, the data pre-processing operation S210 of the data pre-processing module 20 is not limited thereto. For example, the data pre-processing operation in S210 may be performed any time before the synchronization operation of the layout is performed in addition to the order shown in this flowchart or after the layout is generated.

In some example embodiments, the EDA tool 122 may update the layout based on the at least one state variable in S260. As described in detail below, in some example embodiments, the EDA tool 122 may search for an optimal condition by adjusting the received at least one state variable to various values, modifying the circuit, and updating the layout. The EDA tool 122 may update the layout through the synchronization module 30, the simulation module 40, and the reinforcement learning (RL) module 50 based on the optimal condition in S260, and optimize the circuit based on the updated layout in S290.

FIG. 4 is a flowchart for explaining an operation of updating a layout according to some example embodiments.

Referring to FIGS. 3 and 4, in some example embodiments, the EDA tool 122 may update the layout in S260 by reflecting the results of layout synchronization in S262 and post-layout simulation in S265. For example, the EDA tool 122 (or, although not shown, a separate circuit modification module inside or outside the EDA tool 122) may receive the state variable and/or at least one state variable in S230 and modify the circuit in S261. As described above, in some example embodiments, the state variables (e.g., one or more than one state variable) may represent various conditions of a circuit, and the EDA tool 122 may change an existing circuit based on at least one state variable and/or based on more than one the state variables. For example, the at least one state variable may be a variable representing the width of a certain transistor, and the EDA tool 122 may change the width of the certain transistor included in the circuit according to the value of the at least one state variable. In some example embodiments synchronization module 30 may synchronize the layout generated in S200 with the circuit, as described in detail below in S262. For example, the synchronization module 30 may synchronize the changed circuit with the layout according to the at least one state variable in S262.

Thereafter, in some example embodiments, the simulation module 40 may perform post-layout simulation in S265 using the layout synchronized with the changed circuit in S262. For example, the simulation module 40 extracts and simulates parasitic components from the synchronized layout generated in S262 through post-layout simulation in S265, such that information on whether a layout synchronized with the changed circuit in S262 satisfies a target function, and/or characteristic, may be provided.

In some example embodiments, the reinforcement learning (RL) module 50 may calculate the result of the post-layout simulation in S266. In some example embodiments, the reinforcement learning (RL) module 50 may represent a simulation result as a value through the above calculation performed in S266. For example, the reinforcement learning (RL) module 50 may calculate a result value in S266 based on a skew generated in a circuit through post-layout simulation in S265 and/or a duty cycle of an output signal. In some example embodiments, the result value calculated in S266 may include a value obtained by multiplying and summing each skew and/or duty cycle by an appropriate parameter (e.g., a parameter having a positive value). However, the result value calculation method of S266 of the reinforcement learning (RL) module 50 is not limited thereto. For example, the result value calculated in S266 may be a value calculated based on various specifications of the output other than skew and duty cycle.

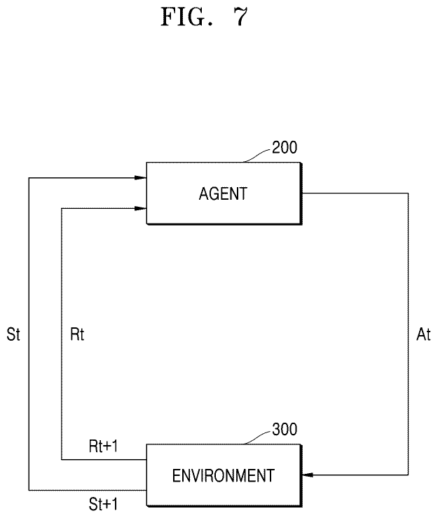

In some example embodiments, the reinforcement learning (RL) module 50 may determine whether to modify the at least one state variable in S267 based on the simulation result value calculated in S266. As described below, in some example embodiments, the reinforcement learning (RL) module 50 may determine that optimization of the circuit (or layout) has not been sufficiently performed based on a result of determining the result value, and in some example embodiments, the reinforcement learning (RL) module 50 may modify the value of the at least one state variable to a more appropriate value. In some example embodiments, the reinforcement learning (RL) module 50 may modify state variables through reinforcement learning, as described in detail below according to some example embodiments with reference to FIG. 7, and search for optimal values of state variables through iterative learning, but example embodiments are not limited thereto. Meanwhile, according to some example embodiments, the reinforcement learning (RL) module 50 may output a layout without modifying the state variables when it is determined that optimization of the circuit has been sufficiently performed based on the result determined through the result value.

For example, when a change in the schematic stage does not reflect the result of the post-layout simulation based on the layout, a difference between the simulation result based on the schematic and the simulation result based on the layout may occur. Therefore, the function and characteristics of the circuit intended by the designer may not be properly implemented, and optimization may not be sufficiently performed.

However, since the circuit design methods according to some example embodiments may modify the layout through synchronization of the circuit and the layout when a change occurs in the circuit, for example, the schematic stage, by unifying both simulations, inconsistency between simulations may be prevented and optimization may be performed more efficiently. For example, the technical purpose achieved by some of the example embodiments may overcome the limitations of existing optimization by performing simulation and optimization by dualizing schematic and layout. Furthermore, since such integrated synchronization may be performed automatically, it is possible to reduce repetitive work of designers (or among designers).

In addition, the technical purpose achieved by some of the example embodiments is to modify and optimize circuits and layouts based on synchronized layouts, that is, by reflecting the results of unified post-layout simulations, so that improved optimization results, that is, better circuit specifications, may be obtained.

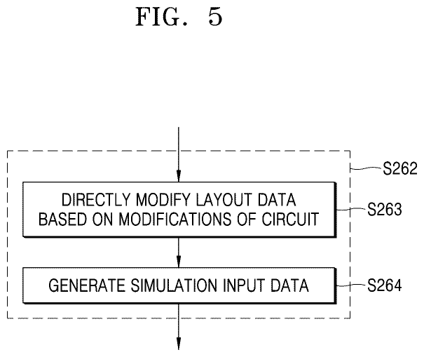

FIG. 5 is a flowchart for explaining a layout synchronization operation according to some example embodiments.

Referring to FIGS. 3 to 5, the synchronization module 30 may generate data to be used in post-layout simulation by synchronizing the layout.

The synchronization module 30 may modify layout data based on corrections generated in the circuit to perform layout synchronization in S263. For example, as described above, the structure of the circuit may be changed according to the at least one state variable, and the synchronization module 30 may directly modify the layout data in S263 generated in S200 (i.e., data defining the layout) to reflect changes in the circuit in the layout. In some example embodiments, using an arbitrary library, the synchronization module 30 may directly modify data defining the layout (e.g., a GDS format file) in S263 without using a separate tool for converting. As an example, the at least one state variable may be a variable indicating a size of a certain transistor. When the at least one state variable has a value different from the existing value, the size of the certain transistor in the circuit may be changed. The synchronization module 30 may perform synchronization to reflect changes in the circuit in the layout by directly modifying data on the size of the certain transistor in data defining the layout in S263.

In some example embodiments, the synchronization module 30 may include a Parasitic Extraction (PEX) module that extracts a parasitic component. The PEX module may generate input data to be used for post-layout simulation in S264. Modified circuit data (e.g., a CKT file) may be generated in S261, and synchronized layout data (e.g., a GDS file) may be generated in S263. The PEX module may extract a parasitic component (e.g., parasitic capacitance) using the circuit data and the layout data. For example, the PEX module may extract parasitic components of synchronized layout data so that post-layout simulation may be smoothly performed. In addition, such an extraction operation of the PEX module may be performed automatically.

As a result, in relation to the circuit design method according to some example embodiments, by performing synchronization by directly modifying the data defining the layout, since the process of converting and correcting layout data using a separate tool for modification and then compressing again may be omitted, the time required for correction may be reduced. In addition, the circuit design method according to some example embodiments may reduce resource consumption because there is no need to use a separate tool for converting layout data.

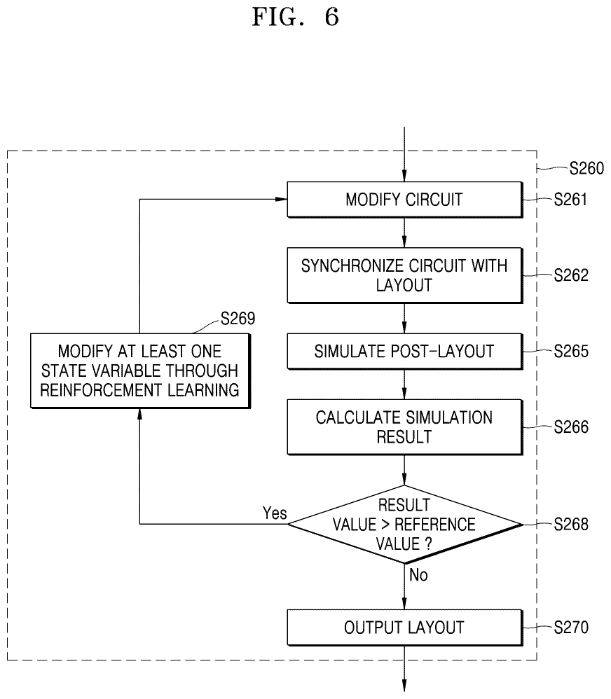

FIG. 6 is a flowchart illustrating an operation of updating a layout through reinforcement learning according to some example embodiments.

Referring to FIGS. 3, 4, and 6, the EDA tool 122 may repeat the search for optimal values of state variables while modifying the circuit through reinforcement learning and perform an optimization operation by synchronizing the optimal values with the layout. The certain process and descriptions of the reinforcement learning are given below with reference to FIG. 7. Descriptions of operations S261 to S266 in this figure are the same as descriptions given above with reference to FIG. 4 and are thus omitted.

In some example embodiments, the reinforcement learning module 50 may perform reinforcement learning based on simulation results, as described below with reference to FIG. 7, and the reinforcement learning module 50 may calculate the resultant value of the simulation and compare the calculated resultant value with a reference value in S268. The reference value may be a preset value by external control or may be changed through reinforcement learning. Also, in some example embodiments the result value may be a value calculated based on an appropriate equation.

According to some example embodiments, the reinforcement learning module 50 may determine that the circuit is better optimized as the result value is smaller based on the following [Equation 1].

$$Result value = α * skew + β * duty + γ * slope + δ * current ( however , α , β , δ > 0 , γ < 0 ) \qquad [ Equation 1 ]$$

As described above, in some example embodiments, as the values of skew and duty cycle decrease, the optimization improves, and values obtained by multiplying each by an appropriate parameter (e.g., a and B having an appropriate positive weight) may be included in the equation for calculating the resultant value. In addition, in some example embodiments, as the value of the Time Rising (TR)/Time Falling (TF) slope increases, the optimization is well done, and a value obtained by multiplying an appropriate parameter (e.g., γ having an appropriate negative weight) may be included in an equation for calculating a resultant value. In some example embodiments, a value obtained by multiplying the value of current by an appropriate parameter (e.g., δ having an appropriate positive weight) may also be included in the equation. However, example embodiments are not limited thereto, and result values may be calculated using various specifications. For example, a value obtained by multiplying an area occupied by an element by a parameter having an appropriate positive weight may also be used.

In some example embodiments, the reinforcement learning module 50 compares the result value and the reference value in S268, and if the result value is less than or equal to the reference value, since it may be determined that the target optimization has been achieved (e.g., target specifications have been satisfied), the layout may be output without modifying one or more than one state variables in S270. However, in some example embodiments, if the result value is greater than the reference value, the current layout does not meet the target specification, so that as described below with reference to FIG. 7, the reinforcement learning module 50 may modify at least one state variable or more than one state variables through reinforcement learning in S269. Accordingly, the circuit may be modified based on the modified state variable as described above, and a layout update operation may be performed as such in S260.

For example, the circuit design method according to some example embodiments may perform optimization by repeating modification of one or more than one state variables through reinforcement learning until a target level is satisfied. More effective optimization may be achieved by repeatedly performing reinforcement learning by reflecting the results of post-layout simulation based on the synchronized layout.

FIG. 7 is a diagram for explaining reinforcement learning according to some example embodiments.

Referring to FIG. 7, the reinforcement learning module 50 may perform reinforcement learning through a reinforcement learning model including an agent 200 and an environment 300. The agent 200 and the environment 300 may be implemented as hardware within a processor or may be implemented as software running on a processor (e.g., the CPU 110). Reinforcement learning refers to a technique in which the agent 200 learns to select a better action by continuously and repeatedly reflecting the changed state (e.g., the size of the transistor) and reward (e.g., the result value based on skew, etc.) according to the selected action (e.g., changing the size of a transistor).

In some example embodiments, the agent 200 may receive the at least one state variable St and the reward variable Rt from the environment 300 and may provide the action variable At to the environment 300. The agent 200 may be trained to provide an action corresponding to a maximum reward in a state received from the environment 300. For example, the agent 200 may include a quality (Q)-table, and may learn by updating the Q-table based on the reward variable Rt received from the environment 300. The Q-table may include a Q-value including a reward variable for each combination of state variables and action variables. The environment 300 may change the at least one state variable St according to the action variable At, and may generate a reward variable Rₜ₊₁ based on the changed state variable Sₜ₊₁.

In some example embodiments, the at least one state variable St may include an initial state variable, and a first state variable to a t-th state variable, and a reward variable Rt may include an initial reward variable and a first reward variable to a t-th reward variable. The action variable At may include a first action variable to a t-th action variable. Each of the state variable St, the reward variable Rt, and the action variable At may be referred to as a state, a reward, and an action.

The agent 200 may receive an initial state variable and an initial reward variable from the environment 300 and may provide a first action variable to the environment 300. The agent 200 may perform reinforcement learning based on the initial state variable and the initial action variable received from the environment 300. The agent 200 may be trained to provide an action variable At corresponding to a maximum reward variable Rt in a state variable St. The agent 200 may output the first action variable through reinforcement learning. The environment 300 may receive the first action variable, change the initial state variable into the first state variable, and generate a first reward variable based on the changed first state variable.

When the agent 200 is given the current state St and the reward Rt for the previous action Aₜ₋₁ from the environment 300, in the current state St, the action At may be determined so that the reward Rt is further improved. In addition, the environment 300 may update the state St to the next state Sₜ₊₁ according to the action At determined by the agent 200, and determine the reward Rₜ₊₁ according to the updated state Sₜ₊₁.

For example, to optimize a circuit, reinforcement learning may be performed to obtain an optimal size of a transistor included in the circuit. The agent 200 may receive an initial state variable indicating an initial size of a transistor and an initial reward variable (or a result value) indicating an initial specification of a circuit from the environment 300. The agent 200 may perform reinforcement learning providing an action variable At corresponding to a reward variable Rt in a state variable St based on the state variable St and the reward variable Rt received as described above. For example, the agent 200 may provide a first action variable for changing the size of a transistor to the environment 300 through reinforcement learning based on an initial state variable and an initial reward variable. The environment 300 may update the initial state to the first state and the initial reward to the first reward based on the first action variable, and generate a first state variable representing the changed size of the transistor and a first reward variable representing the result value changed accordingly. The environment 300 provides the first state variable and the first reward variable to the agent 200, so that reinforcement learning may be performed in the same way.

As described above, the circuit design method according to some example embodiments may optimize the circuit by determining the optimal skew and duty cycle through the reinforcement learning module 50, considering both the skew and the duty cycle according to state variables in a system in which reinforcement learning is implemented (e.g., the circuit design system 100 of FIG. 1).

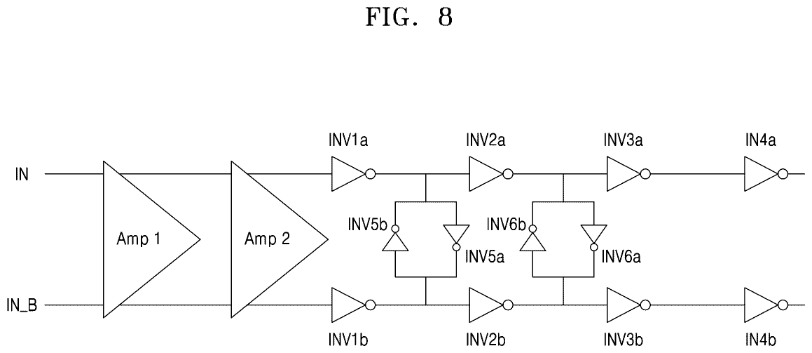

FIG. 8 is a circuit diagram to which a circuit design method according to some example embodiments is applied.

Referring to FIGS. 3, 4, and 8, a circuit design method according to some example embodiments may be applied to a Current Mode Logic (CML) 2 Complementary Metal-Oxide Semiconductor (CMOS) (C2C) circuit. The C2C circuit may include a first amplifier Amp 1, a second amplifier Amp 2, (1-1)-th to (6-1)-th inverters INV1a to INV6a, and (1-2)-th to (6-2)-th inverters INV1b to INV6b.

The first amplifier Amp 1 may receive the first input signal IN and the first inverted input signal IN_B, and may output and provide the signals as input signals to the second amplifier Amp 2. The (1-1)-th inverter INV1a and the (1-2)-th inverter INV1b are connected to the output terminal of the second amplifier Amp 2, and each may receive one of the output signals of the second amplifier Amp 2. In the same way, the (4-1)-th inverter INV4a and the (4-2)-th inverter INV4b may be connected in series. The (5-1)-th inverter INV5a may be connected to an output terminal of the (1-1)-th inverter INV1a and may provide an output signal to the (2-2)-th inverter INV2b. The (5-2)-th inverters INV5b to (6-2)-th inverters INV6b may also be connected in the same manner. For example, calculations for circuit specifications such as skew and duty cycle may be performed based on output signals from the (4-1)-th inverter INV4a and the (4-2)-th inverter INV4b.

In some example embodiments, the state variable of FIG. 3 may be a variable indicating the size of each of the transistors included in the plurality of inverters INV1a to INV6b. The EDA tool 122 may modify the size of each transistor included in the C2C circuit based on the state variable. The synchronization module 30 may perform layout synchronization based on changes in the circuit according to the state variable, and the simulation module 40 may perform post-layout simulation based on the synchronized layout. The reinforcement learning module 50 may calculate the result value (or reward variable) based on the skew and/or duty cycle using the signals output from the (4-1)-th inverter INV4a and the (4-2)-th inverter INV4b, and as described above with reference to FIG. 7, perform reinforcement learning on the size of the transistor for optimizing the circuit based on the result value. Through this process, the EDA tool 122 may optimize the C2C circuit.

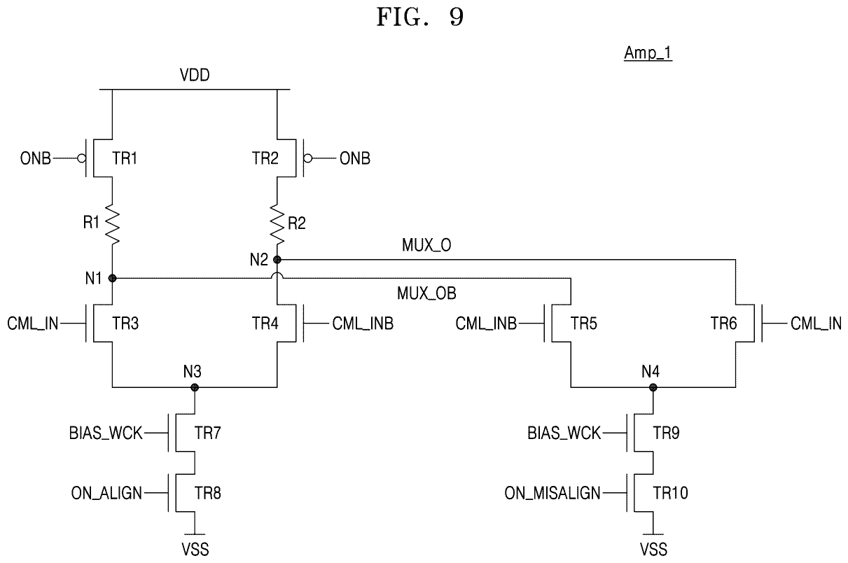

FIG. 9 is a circuit diagram according to some example embodiments showing the CML circuit of FIG. 8.

Referring to FIGS. 8 and 9, the first amplifier Amp 1 may include first to tenth transistors TR1 to TR10, and a resistor R1 and a resistor R2. Control signals ONB, CML_IN, CML_INB, BIAS_WCK, ON_ALIGN, and ON_MISALIGN for turning on or off each of the transistors may be applied to the gate of each of the transistors included in the first amplifier Amp 1, as shown.

One of the ends of the first and second transistors TR1 and TR2 may receive the power supply voltage VDD, and the other ends thereof may be connected to the resistors R1 and R2. The resistor R1 and the resistor R2 may be connected to the first node N1 and the second node N2, respectively. The third transistor TR3 and the fourth transistor TR4 may be connected to the seventh transistor TR7 through the third node N3, and the eighth transistor TR8 may be between the seventh transistor TR7 and the ground voltage VSS line. In the same way, one of the ends of the fifth and sixth transistors TR5 and TR6 may be respectively connected to the first and second nodes N1 and N2, and the other ends thereof may be connected to the ninth transistor TR9 through the fourth node N4. The tenth transistor TR10 may be between the ninth transistor TR9 and the ground voltage VSS line. The input control signal CML_IN and the inverted input control signal CML_INB, the third control signal ON_MISALIGN and the second control signal ON_ALIGN may be complementary to each other, and accordingly, the third and sixth transistors TR3 and TR6, the fourth and fifth transistors TR4 and TR5, and the ninth transistor TR9 and the tenth transistor TR10 may be turned on or off in a complementary manner.

In some example embodiments, the state variable of FIG. 3 may be a variable representing the size of the third to sixth transistors TR3 to TR6. The EDA tool 122 may modify the size of the transistors included in the CML circuit based on the state variable. The synchronization module 30 may perform layout synchronization based on the size change of the transistors according to the state variable, and the simulation module 40 may perform post-layout simulation based on the synchronized layout. In the same manner, the reinforcement learning module 50 may calculate the result value (or reward variable) based on the skew and/or duty cycle using the signals output from the (4-1)-th inverter INV4a and the (4-2)-th inverter INV4b, and as described above with reference to FIG. 7, perform reinforcement learning on the size of the transistor based on the result value. Through this process, the EDA tool 122 may optimize the CML circuit.

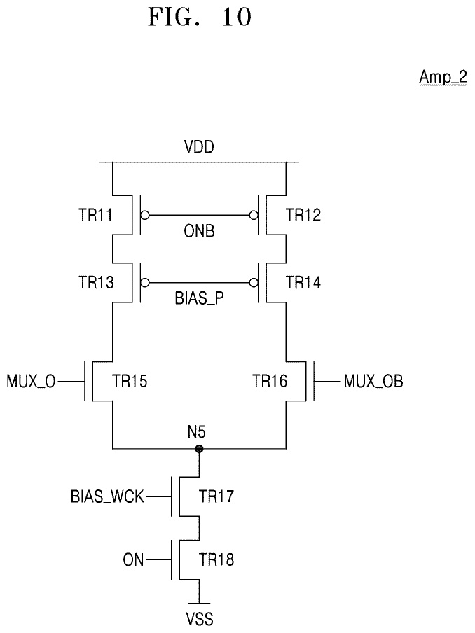

FIG. 10 is a circuit diagram illustrating a complementary metal-oxide-semiconductor (CMOS) circuit of FIG. 8.

Referring to FIGS. 8 to 10, the second amplifier Amp 2 may include eleventh to seventeenth transistors TR11 to TR17. As illustrated, control signals ONB, BIAS_P, MUX_O, MUX_OB BIAS_WCK, and ON may be applied to gates of each of the transistors included in the first amplifier Amp 1.

The eleventh and thirteenth transistors TR11 and TR13 may be connected in series and between the power supply voltage VDD line and the fifteenth transistor TR15, and the twelfth and fourteenth transistors TR12 and TR14 may be also connected in series and between the power supply voltage VDD line and the sixteenth transistor TR16. The fifteenth and sixteenth transistors TR15 and TR16 may be connected to the seventeenth transistor TR17 through the fifth node N5, and the eighteenth transistor TR18 may be between the seventeenth transistor TR17 and the ground voltage VSS line. The input control signal MUX_O and the inverted input control signal MUX_OB may be complementary signals to each other, and thus, the fifteenth and sixteenth transistors TR15 and TR16 may be turned on or off complementarily.

In some example embodiments, the state variable of FIG. 3 may be a variable representing the size of the fifteenth transistor TR15 and the sixteenth transistor TR16. The EDA tool 122 may modify the size of the transistors included in the CMOS circuit based on the state variable. In the same manner, the reinforcement learning module 50 may calculate the result value (or reward variable) based on the skew and/or duty cycle using the signals output from the (4-1)-th inverter INV4a and the (4-2)-th inverter INV4b, and as described above with reference to FIG. 7, perform reinforcement learning on the size of the transistor based on the result value. Through this process, the EDA tool 122 may optimize the CMOS circuit.

As described herein, one or more of the elements disclosed above may include or be implemented in one or more processing circuitries such as hardware including logic circuits; a hardware/software combination such as a processor executing software; or a combination thereof. For example, the processing circuitries more specifically may include, but are not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

As described herein, any devices, electronic devices, modules, models, units, and/or portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphic processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Any of the memories described herein may be a non-volatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

While the inventive concepts have been shown and described with reference to some example embodiments thereof, it will be understood that various changes in form and details may be made therein without departing from the spirit and scope of the following claims.

What is claimed is:

1. A method of designing an integrated circuit, the method comprising:
generating a layout based on data defining a circuit;
receiving at least one state variable of reinforcement learning; and
updating the layout based on the at least one state variable,
wherein the updating of the layout comprises
modifying the circuit based on the at least one state variable,
synchronizing the circuit with the layout,
performing a post-layout simulation based on a result of the synchronization,
calculating a result value of the post-layout simulation, and
determining whether to modify the at least one state variable through the reinforcement learning according to the result value.

2. The method of claim 1, further comprising performing data pre-processing to perform the synchronizing before the updating of the layout.

3. The method of claim 1, wherein the synchronizing of the circuit with the layout comprises directly modifying data defining the layout without a conversion process based on the modification in the circuit according to the at least one state variable.

4. The method of claim 3, wherein the synchronizing of the circuit with the layout comprises extracting a parasitic component based on the modified circuit and the layout to generate input data of the post-layout simulation.

5. The method of claim 1, wherein the determining whether to modify the at least one state variable comprises comparing the result value with a reference value to determine whether to modify the at least one state variable.

6. The method of claim 5, wherein the determining whether to modify the at least one state variable comprises outputting the layout without modifying the at least one state variable if the result value is less than or equal to the reference value.

7. The method of claim 5, wherein the determining whether to modify the at least one state variable comprises repeating the updating of the layout through the modification of the at least one state variable when the result value is greater than the reference value, until the result value of the simulation is less than or equal to the reference value.

8. The method of claim 1, wherein the reinforcement learning is based on a Q-learning reinforcement learning technique.

9. The method of claim 1, wherein the at least one state variable is a variable representing at least one of a width or length of a transistor included in the circuit.

10. The method of claim 1, wherein the result value of the simulation comprises a value for at least one of a skew occurring in the circuit or a duty cycle of an output signal.

11. An integrated circuit design system comprising:
a memory configured to store instructions; and
at least one processor configured to communicate with the memory and optimize a circuit through simulation by executing the instructions,
wherein the at least one processor generates a layout based on data defining the circuit,
receives at least one state variable of the circuit,
modifies the circuit based on the at least one state variable,
synchronizes the circuit with the layout,
performs a post-layout simulation based on a result of the synchronization,
calculates a result value of the post-layout simulation, and
determines whether to modify the at least one state variable according to the result value.

12. The system of claim 11, wherein the at least one processor performs data preprocessing before performing the synchronization.

13. The system of claim 11, wherein the at least one processor directly modifies data defining the layout based on the modification in the circuit according to the at least one state variable without a conversion process.

14. The system of claim 11, wherein the at least one processor extracts a parasitic component using the layout synchronized with the modified circuit.

15. The system of claim 11, wherein the at least one processor modifies the at least one state variable based on reinforcement learning when it is determined to modify the at least one state variable according to the result value.

16. The system of claim 11, wherein the at least one processor outputs the layout when it is determined not to modify the at least one state variable according to the result value.

17. The system of claim 11, wherein the at least one state variable is a variable representing a size of a transistor included in the circuit.

18. A method of designing an integrated circuit, the method comprising:
generating a layout based on data defining a circuit;
receiving at least one state variable of reinforcement learning;
modifying the circuit based on the at least one state variable;
synchronizing the circuit with the layout;
generating input data using the synchronized circuit and the layout;
performing a post-layout simulation based on the input data; and
determining whether to perform the reinforcement learning on the at least one state variable according to a result of the post-layout simulation.

19. The method of claim 18, wherein the synchronizing of the circuit with the layout comprises directly modifying data defining the layout without a conversion process based on the modification in the circuit according to the at least one state variable.

20. The method of claim 18, wherein the determining whether to perform the reinforcement learning comprises:
modifying the at least one state variable based on the reinforcement learning, when the reinforcement learning is performed; and
outputting the layout without modifying the at least one state variable, when the reinforcement learning is not performed.
